(19) United States
(12) Patent Application Publication
(10) Pub. No.: US 2012/0287073 A1
(43) Pub. Date: Nov. 15, 2012

(54) SELECTION OF A SELECTION ITEM ON A TOUCH-SENSITIVE DISPLAY

(76) Inventors: Pavlo Melnyk, Waterloo (CA); Mihal Lazaridis, Waterloo (CA); Jordanna Kwok, Markham (CA)

(21) Appl. No.: 13/560,687

(22) Filed: Jul. 27, 2012

Related U.S. Application Data
(63) Continuation of application No. 12/818,865, filed on Jun. 18, 2010.
(60) Provisional application No. 61/218,565, filed on Jun. 19, 2009.

(51) Int. Cl. G06F 3/041

(52) U.S. Cl. 345/173

(57) ABSTRACT

A focused selection item is displayed on a touch-sensitive display of an electronic device. An actuation of a physical key is detected. At least one function associated with the focused selection item is performed in response to the actuation.

### CROSS-REFERENCE TO RELATED APPLICATION

This application claims the benefit of U.S. patent application Ser. No. 12/818,865, filed Jun. 18, 2010, the entire content of which is incorporated herein by reference.

### FIELD OF TECHNOLOGY

The present disclosure relates to electronic devices, including but not limited to portable electronic devices having touch screen displays and their control.

### BACKGROUND

Electronic devices, including portable electronic devices, have gained widespread use and may provide a variety of functions including, for example, telephonic, electronic messaging and other personal information manager (PIM) application functions. Portable electronic devices include, for example, several types of mobile stations such as simple cellular telephones, smart telephones, wireless personal digital assistants (PDAs), and laptop computers with wireless 802.11 or Bluetooth capabilities. These devices run on a wide variety of networks from data-only networks such as Mobitex® and DataTAC® networks to complex voice and data networks such as GSM/GPRS, CDMA, EDGE, UMTS and CDMA2000 networks.

Portable electronic devices such as PDAs or smart telephones are generally intended for handheld use and ease of portability. Smaller devices are generally desirable for portability. A touch screen display for input and output is particularly useful on such handheld devices, as such handheld devices are small and are therefore limited in space available for user input and output devices. Further, the screen content on the touch screen display devices may be modified depending on the functions and operations being performed. Even still, these devices have a limited area for rendering content on the touch screen display and for rendering features or icons, for example, for user interaction. With continued demand for decreased size of portable electronic devices, touch screen displays continue to decrease in size.

Improvements in touch screen devices are therefore desirable.

### BRIEF DESCRIPTION OF THE DRAWINGS

FIG. 1 is a block diagram of a portable electronic device in accordance with the disclosure.

FIG. 2 is a front view of the portable electronic device having a touch-sensitive display in accordance with the disclosure.

FIG. 3 illustrates a portable electronic device in which a dialog box including selection items is presented on the touch-sensitive display in accordance with the disclosure.

FIG. 4 illustrates a portable electronic device in which a dialog box including selection items is presented on the displayable area of the touch-sensitive display in accordance with the disclosure.

FIG. 5 is a flowchart illustrating a method of displaying selection items and detecting input in accordance with the disclosure.

### DETAILED DESCRIPTION

Conventionally, when options are presented on a touch-sensitive display of a portable electronic device, the portable electronic device detects a touch on the touch-sensitive display to select one of the items. The user spends time to locate the desired selection item and to touch the item to select it. Once the selection is made, the processing of the touch event by the device may require some length of time to process. When selections, such as confirmation requests in dialog boxes, are repeatedly presented to a user, the user interaction may be very time-consuming, as the user moves the selector, e.g., a finger or stylus, along the touch-sensitive display.

This disclosure provides methods of selecting an item on a touch-sensitive display of an electronic device. The electronic device, which may be a portable electronic device, has a touch-sensitive display and a physical key. One or more selection items are displayed on the touch-sensitive display. One of the selection items is displayed as a focused selection item. When the user operates the physical key to select the focused selection item, the actuation of the physical key is detected by the portable electronic device. At least one function associated with the focused selection item is performed.

The physical key may allow for the user to select the focused selection item without further interaction with the touch-sensitive display. The physical key may be any physical or mechanical control on the electronic device, such as a menu key, a mute key, a programmable function key, a volume key, track pad, trackball, optical joystick, and so forth. The physical key may be disposed on any part of the portable electronic device. A user-programmable key may be programmed to function as the physical key.

Before detecting the actuation of the physical key, the method may further include detecting a touch that changes the focused selection item to a second item of the one or more selection items.

The touch-sensitive display may be configured to detect a selection of the first selection item by detecting a touch associated with the first selection item.

The one or more selection items may be displayed in a dialog box displayed on the touch-sensitive display. The dialog box may occupy up to an entire display area of the touch-sensitive display.

A computer readable medium is also disclosed. The computer readable medium may store instructions for execution by a processor of a portable electronic device which causes the portable electronic device to implement any of the methods described herein.

An electronic device, which may be a portable electronic device, is also disclosed. The electronic device includes a physical key, a touch sensitive display, and a microprocessor. The touch-sensitive display is configured to display one or more selection items. A first selection item is displayed as a focused selection item. The microprocessor is configured to detect an actuation of the physical key and to perform at least one function associated with the focused selection item.

The physical key may be a menu key or any other key or physical control on the electronic device.

The microprocessor may be further configured to, before detecting the actuation of the physical key, detect a touch that changes the focused selection item to a second selection item of the one or more selection items.

The touch-sensitive display may be configured to detect a selection of the first selection item by detecting a touch associated with the first selection item.

The one or more selection items may be displayed in a dialog box displayed on the touch-sensitive display. The dialog box may occupy an entire displayed area of the touch-sensitive display.

The physical key may be disposed on any side of the electronic device.

The physical key may be a user-programmable key that is configurable to perform as the physical key.

Another embodiment of the method is disclosed. An electronic device, which may be portable, is provided having a touch-sensitive display and a physical key. On the touch-sensitive display, a focused selection item is displayed. An actuation of the physical key is detected. At least one function associated with the focused selection item is performed.

The focused selection item may be a character on a keyboard displayed on the touch-sensitive display.

The focused selection item may be an icon for an application displayed on the touch-sensitive display.

By configuring a physical key to select a focused selection item, which often is the default selection item among the options, a user may press the physical key rather than locating the appropriate selection item, and touching the appropriate selection item to select the selection item. The use of a physical key, which may be conveniently located near a finger or thumb, may be faster and may avoid potential user frustration with the selection of an option via the touch-sensitive display. Accordingly, a user may handle dialog boxes associated with options for selection without interaction with the touch-sensitive display.

For simplicity and clarity of illustration, reference numerals may be repeated among the figures to indicate corresponding or analogous elements. In addition, numerous specific details are set forth in order to provide a thorough understanding of the embodiments described herein. The embodiments described herein may be practiced without these specific details. In other instances, well-known methods, procedures and components have not been described in detail so as not to obscure the embodiments described herein. Also, the description is not to be considered as limited to the scope of the embodiments described herein.

The disclosure generally relates to an electronic device, which in the embodiments described herein is a portable electronic device. Examples of portable electronic devices include mobile, or handheld, wireless communication devices such as pagers, cellular phones, cellular smart-phones, wireless organizers, personal digital assistants, wirelessly enabled notebook computers, and the like. The portable electronic device may also be a portable electronic device without wireless communication capabilities such as a handheld electronic game device, digital photograph album, digital camera, or other device.

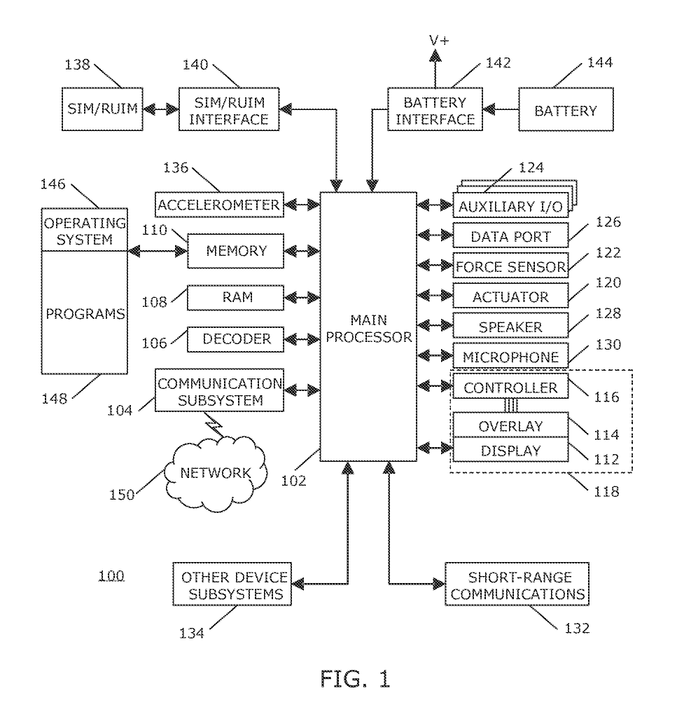

A block diagram of an example of an embodiment of a portable electronic device 100 is shown in FIG. 1. The portable electronic device 100 includes a number of components such as a processor 102 that controls the overall operation of the portable electronic device 100. Communication functions, including data and voice communications, are performed through a communication subsystem 104. Data received by the portable electronic device 100 is decompressed and decrypted by a decoder 106. The communication subsystem 104 receives messages from and sends messages to a wireless network 150. The wireless network 150 may be any type of wireless network, including, but not limited to, data-centric wireless networks, voice-centric wireless networks, and dual-mode networks that support both voice and data communications over the same physical base stations. The portable electronic device 100 may be a battery-powered device that includes a battery interface 142 for receiving one or more rechargeable batteries 144.

The processor 102 also interacts with additional subsystems such as a Random Access Memory (RAM) 108, a memory 110, a display 112 with a touch-sensitive overlay 114 coupled to an electronic controller 116 that together make up a touch-sensitive display 118, also referred to as a touch screen display, an actuator 120, a force sensor 122, an auxiliary input/output (I/O) subsystem 124, a data port 126, a speaker 128, a microphone 130, short-range communications 132 and other device subsystems 134. The processor 102 interacts with the touch-sensitive overlay 114 via the electronic controller 116. Information, such as text, characters, symbols, images, and other items that may be displayed on a portable electronic device, is displayed on the touch-sensitive display 118 via the processor 102.

When a touch is detected on the touch-sensitive display 118, a location, such as an x and y coordinate of the touch is determined, as known in the art, and the location of the touch may be associated with information displayed via a graphical user interface. A touch may comprise one or more of various actions, including, but not limited to, one or more contacts, contact with respect to a pressure or other threshold, contact including movement, and various combinations thereof. A touch may be detected from a selector that may be any suitable object, such as a finger, thumb, appendage, or other items, for example, a stylus, pen, or other pointer, depending on the nature of the touch-sensitive display 118. Multiple simultaneous touches may be detected.

One or more actuators 120 may be depressed by applying sufficient force to the touch-sensitive display 118 to overcome the actuation force of the actuator 120. The actuator 120 may be actuated by pressing anywhere on the touch-sensitive display 118. The actuator 120 may provide input to the processor 102 when actuated. Actuation of the actuator 120 may result in provision of tactile feedback. When force is applied, the touch-sensitive display 118 is depressible, pivotable, and/or movable. The actuator may be any suitable actuator, including mechanical and/or electrical actuators.

A selection may be detected from signals from one or more of the touch-sensitive display 118, one or more actuators 120, one or more force sensors 122, and so forth. Detection of a double tap on an area associated with an icon rendered on the touch-sensitive display 118 or actuation of an actuator 120 are but a few examples of input that may be processed as a selection of a selection item.

The processor 102 may also interact with an accelerometer 136 as shown in FIG. 1. The accelerometer 136 may include a cantilever beam with a proof mass and suitable deflection sensing circuitry. The accelerometer 136 may be utilized for detecting direction of gravitational forces or gravity-induced reaction forces.

To identify a subscriber for network access according to the present embodiment, the portable electronic device 100 uses a Subscriber Identity Module or a Removable User Identity Module (SIM/RUIM) card 138 inserted into a SIM/RUIM interface 140 for communication with a network such as the wireless network 150. Alternatively, user identification information may be programmed into the memory 110.

The portable electronic device 100 also includes an operating system 146 and software components 148 that are executed by the processor 102 and are typically stored in a persistent, updatable store such as the memory 110. Additional applications may be loaded onto the portable electronic device 100 through the wireless network 150, the auxiliary I/O subsystem 124, the data port 126, the short-range communications subsystem 132, or any other suitable device subsystem 134.

In use, a received signal such as a text message, an e-mail message, or web page download is processed by the communication subsystem 104 and input to the processor 102. The processor 102 processes the received signal for output to the display 112 or alternatively to the auxiliary I/O subsystem 124. A subscriber may also compose data items, such as e-mail messages, for example, which may be transmitted over the wireless network 150 through the communication subsystem 104. For voice communications, the overall operation of the portable electronic device 100 is substantially similar except that the received signals are output to the speaker 128 and signals for transmission are generated by the microphone 130.

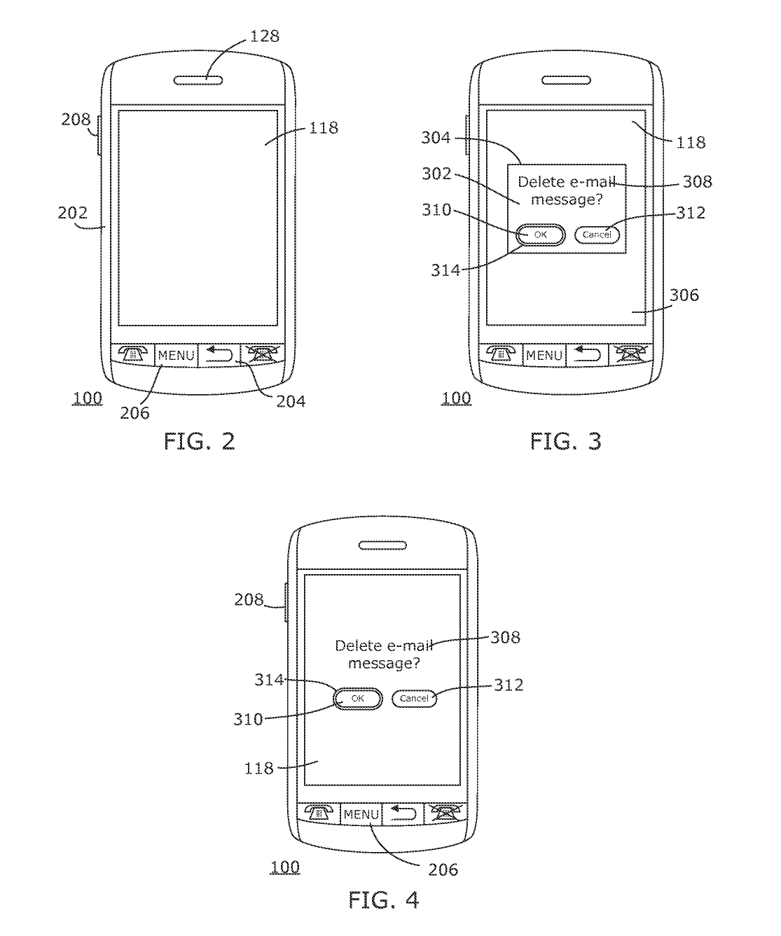

A front view of the portable electronic device 100 is shown in FIG. 2. The portable electronic device 100 includes a housing 202 that supports the touch-sensitive display 118, a set of mechanical or physical buttons 204, and the speaker 128. From left to right, the set of mechanical buttons 204 include a send key, a menu key 206, an escape key, and an end/power key. Another mechanical or physical key 208 is also disposed on the side of the housing 202 of the portable electronic device 100. The key 208 may be easily accessible by a thumb or finger of the hand that holds the portable electronic device 100 while the other hand operates of the touch-sensitive display 118. Although the key 208 is shown on the left side of the portable electronic device 100, the key 208 may also be located on the right side or other locations on the device 100, or may be an existing key on the portable electronic device 100. The key 208 may be located for ergonomic convenience. Additional keys, such as volume keys or programmable keys, may be located on the left and/or right side of the housing 202, such that left and right-handed users may configure a key on either side to serve as a selection key. Any of the physical keys on the device 100 may be also programmable such that they may serve as the selection key. For example, a track pad, trackball, optical joystick, or other physical or mechanical control may be utilized, which control may be disposed on the front side of the housing or any part of the portable electronic device 100. Additionally, physical key(s) need not be dedicated to act only as a selection keys. A selection key may have different functionality based on different operational state of the electronic device. For example, a volume key may adjust audio level during telephone calls, but may be used as a selection key when information input, such as when a selection item is displayed on the electronic device.

During the operation of the portable electronic device 100, one or more selection items may be displayed on the touch-sensitive display 118 to prompt the user for information, such as in the dialog boxes or windows shown in FIG. 3 and FIG. 4. For example, when the user attempts to delete an e-mail message, the portable electronic device 100 may display a dialog box that requests confirmation of the deletion action. Other known dialog boxes may relate to save operations, notifications, and other such events. Dialog boxes may require that the user choose one of the selection items before the user is allowed to perform another action or the user may perform other actions without choosing one of the selection items. A dialog box may prompt the user for any type(s) of information and/or input and should not be limited to the examples used herein, as these examples are only for purposes of illustration.

The selection items do not need to be a part of a dialog box. The selection items may be included as any part or all of the displayable area of the touch-sensitive display 118.

Selection items are displayed in one form of a dialog box 302, which may be of any suitable size, on the touch-sensitive display 118 in FIG. 3. In this example, the user is prompted for confirmation of the deletion of an e-mail. The dialog box 302 has a border 304, outside of which a background area 306 is displayed. A prompt 308 and two selection items 310 and 312, displayed as virtual buttons, are also displayed on the touch-sensitive display 118. An example of a dialog box displayed in the entire displayable area of the touch-sensitive display 118 is shown in FIG. 4.

The selection items 310 and 312 are shown as soft or virtual buttons with text displayed in the area of the button. The selection items may take forms other than virtual buttons. The selection items may alternatively include graphical elements, for example, symbols, pictures, icons, and/or borders, and may be combined with text. Although two selection items 310 and 312 are shown displayed on the touch-sensitive display 118 in FIG. 3 and FIG. 4, one or more selection items may be displayed. For example, a message may displayed in a dialog box with a single selection item that may be selected, for example, to exit the dialog box and dispose of the message. In other situations, two or more selection items may be displayed on the touch-sensitive display 118.

The “OK” selection item 310 has an extra border 314 surrounding the selection item 310 that indicates that selection item 310 is the focused selection item. A focused selection item is displayed in a different manner than other selection items. Typically, no more than one item is the focused selection item at a given time because the focused selected item is selected pending the occurrence of a predetermined detected action, such as the actuation of a physical key. In FIG. 3 and FIG. 4, the selection item 310 is identified as the focused selection item by the extra border 314 surrounding the selection item 310. Focused selection items may be identified in any number of other ways including, but not limited to, coloration or patterning of all or part of the focused selection item, alternative presentation of text that is part of the focused selection item, e.g., bolding, italicizing, underlining, highlighting, or text size, increasing the displayed area, a fanciful border, any combination of identifiers, and so forth.

When one or more selection items are displayed on the touch-sensitive display 118, the portable electronic device 100 is configured to select the focused selection item using a physical key, such as menu key 206 or the key 208 located elsewhere on the portable electronic device 100. The device 100 may be configured such that one or more of the available keys may be programmable to function as the selection key. Some keys are more advantageously utilized or programmed as the selection key than others. For example, keys located near where a thumb may rest on the portable electronic device 100 are more advantageous. Conversely, some keys may advantageously be avoided for use as a selection key, such as a power key or a key assigned to answer a phone key. Additionally, some keys may be utilized as selection keys during presentation of a dialog box, but may have other functionality when a dialog box is not present. For example, a mute or volume key could serve as a selection key in the presence of a dialog box, but may function to affect audio when a dialog box is not present.

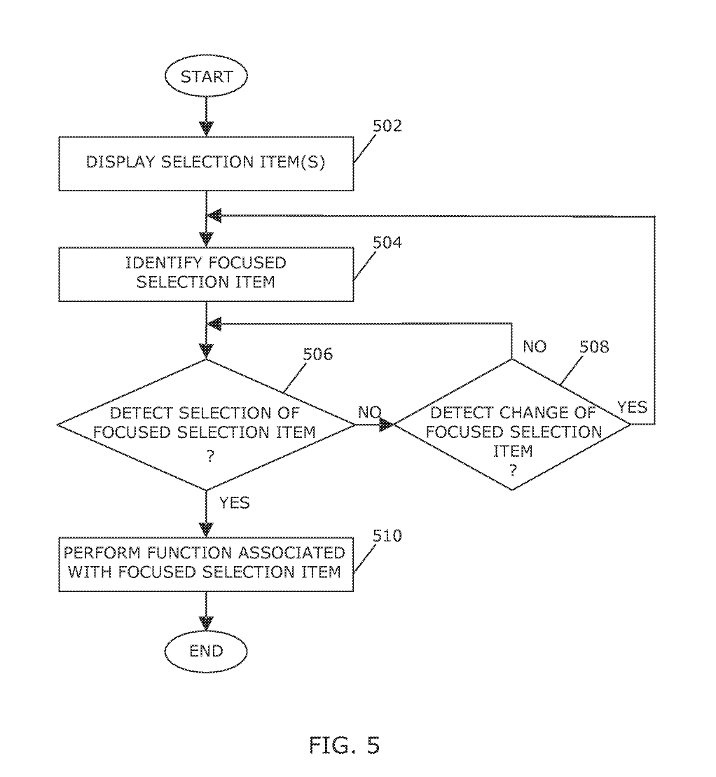

A flowchart illustrating a method of displaying selection items and detecting input is shown in FIG. 5. The method may be carried out by software executed, for example, by the processor 102. Coding of software for carrying out such a method is within the scope of a person of ordinary skill in the art given the present description. The method, or parts of the method, may also be carried out by hardware, such as application-specific integrated circuits (ASICs), or any other logic device or devices. The method may contain additional or fewer processes than shown and/or described, and may be performed in a different order. Computer-readable code executable by at least one processor of the portable electronic device to perform the method may be stored in a computer-readable medium. One or more selection items are displayed 502 on the touch-sensitive display 118. The portable electronic device 100 may display the selection item(s) in accordance with any application or software that may be running, including, but not limited to, in response to a previous action on the device, e.g., a dialog box confirming an instruction to delete an e-mail, changing of a setting, send an text message, or the like, in response to a timed event such as a notification alarm, in response to a non-timed event such as receiving a call, e-mail, text message, or other update, and so forth.

When the selection item(s) is (are) displayed on the touch-sensitive display 118, one of the selection items is identified 504 as the focused selection item, as described above. When selection of the focused selection item is not detected 506, the process continues at 508, where detection of the change of a focused selection item takes place. For example, a touch associated with selection item 312 in FIG. 3 may be detected. Other methods of selecting a change in focused selection item may be utilized. When a change is detected, the new selection item, e.g., selection item 312, is identified 504 as the focused selection item. When no change is detected, the process continues at 506.

The portable electronic device in this example may detect selection by either detecting actuation of the selection key, as described above, or detecting an appropriate touch on the touch-sensitive display 118, such as a touch that depresses the touch-sensitive display 118 with sufficient force, a double-touch, a swipe, or other touch event. When a selection of the focused selection item is detected 506, a function associated with the focused selection item is performed 510. From the example of FIG. 3, when the “OK” selection item 310 is selected, the e-mail message is deleted, and the e-mail application continues. When the “Cancel” selection item 312 is selected, the e-mail message is not deleted, and the e-mail application continues. The function performed may be complex, such as entering the phone application and dialing a phone number, or may be very simple, such as removing the selection items and any associated dialog box. When processing detection of actuation of the selection key is faster than processing detection of a touch event, the use of the selection key to as the mechanism to select a selection item is faster than selection by touch event.

The disclosed selection key techniques offer many potential advantages over a device that provides only touch event processing to choose a selection item displayed on a touch-sensitive display. The selection key may be located where the user may already have a finger or thumb, e.g., on the side of the housing near the thumb/finger of the hand that holds the device 100, and the only motion required is the actuation of the selection key. The user may thus avoid finger movements to various locations on the touch-sensitive display 118. When performing a repetitive task that regularly requires navigation through a dialog box, a user may be able to handle the dialog box more quickly with the physical selection key. Having an option of selection by a physical control provides a user with an option that may reduce entry time of information, thereby reducing power consumption.

Although the use of a physical key as a selection key is described with respect to selection items displayed, for example, in dialog boxes, other potential applications of a selection key exist. For example, a keyboard may be displayed on a touch sensitive display 118. Although the device 100 may detect the touch of the displayed keys by interaction with the touch-sensitive display 118, the use of a physical selection key, in addition to touch options, provides options and advantage when selecting a displayed key. For example, the finger may be lifted from above the key for better visual identification of the identified key before selection. Similarly, a selection key may be utilized to select icons, images, or other graphical elements.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

1. A method comprising:
displaying, on a touch-sensitive display of an electronic device, one or more selection items;
detecting a touch that identifies a first selection item of the one or more selection items;
displaying the first selection item as a focused selection item;
detecting an actuation of a physical key;
performing at least one function associated with the focused selection item in response to the actuation.

2. The method of claim 1, wherein the physical key is one of a track pad, an optical joystick, a volume control key, a mute key, and a menu key.

3. The method of claim 1, further comprising detecting a touch that changes the focused selection item to a second selection item of the one or more selection items.

4. The method of claim 1, wherein the touch-sensitive display is separate from the physical key.

5. The method of claim 1, wherein the physical key performs an additional function as well as selecting the focused selection item.

6. The method of claim 5, wherein the physical key performs the additional function when no focused selection item is displayed.

7. The method of claim 1, wherein the at least one function associated with the focused selection item is not performed in response to detecting the touch.

8. The method of claim 1, wherein the physical key is a physical control disposed on the electronic device.

9. The method of claim 1, further including setting a programmable key to function as the physical key.

10. (canceled)

11. An electronic device comprising:
a touch-sensitive display configured to display one or more selection items, wherein a first selection item of the one or more selection items is identified by detecting a touch and is displayed as a focused selection item;
a physical key;
a processor configured to:
detect an actuation of the physical key;
in response to the detecting, perform at least one function associated with the focused selection item.

12. The electronic device of claim 11, wherein the physical key is one of a track pad, an optical joystick, a volume control key, a mute key, and a menu key.

13. The electronic device of claim 11, wherein the processor is further configured to, before detecting the actuation of the physical key, detect a touch that changes the focused selection item to a second selection item of the one or more selection items.

14. The electronic device of claim 11, wherein the touch-sensitive display is separate from the physical key.

15. The electronic device of claim 11, wherein the physical key performs a function in addition to selecting the focused selection item.

16. The electronic device of claim 11, wherein the at least one function associated with the focused selection item is not performed in response to detecting the touch.

17. The electronic device of claim 11, wherein the physical key is a physical control disposed on the electronic device.

18. The electronic device of claim 11, wherein the physical key is a programmable key that is configurable to perform as the physical key.

19. A method comprising:
displaying, on a touch-sensitive display of an electronic device, a focused selection item identified by detecting a touch on the touch-sensitive display;
detecting an actuation of a physical key;
in response to the actuation, performing at least one function associated with the focused selection item.

20. The method of claim 19, wherein the focused selection item is a character on a keyboard displayed on the touch-sensitive display.

21. The method of claim 19, wherein the focused selection item is an icon for an application displayed on the touch-sensitive display.

22. The method of claim 1, wherein the physical key is separate from a keyboard of the electronic device.

23. The method of claim 1, wherein the one or more selection items are displayed in a dialog box on the touch-sensitive display.

24. A method comprising:
displaying, on a touch-sensitive display of an electronic device, one or more selection items;
detecting a touch that identifies a first selection item of the one or more selection items;
displaying the first selection item as a focused selection item;
detecting an actuation of a physical key, wherein the physical key performs an additional function as well as selecting the focused selection item when no focused selection item is displayed;
performing at least one function associated with the focused selection item in response to the actuation.
